(19) United States
(12) Patent Application Publication
(10) Pub. No.: US 2015/0159407 A1
(43) Pub. Date: Jun. 11, 2015

(54) DOOR LATCH ASSEMBLY AND SYSTEM

(71) Applicants: Jean Bernard Didier, Anould (FR); Dominique Wurtz, Moyenmoutier (FR)

(72) Inventors: Jean Bernard Didier, Anould (FR); Dominique Wurtz, Moyenmoutier (FR)

(21) Appl. No.: 14/564,459

(22) Filed: Dec. 9, 2014

(30) Foreign Application Priority Data
Dec. 10, 2013 (FR) 1362345

(51) Int. Cl. E05B 81/68

(52) U.S. Cl. CPC E05B 81/68

(57) ABSTRACT

In one non-limiting embodiment, a latch assembly includes a claw movable between a latched position and an unlatched position, and a pawl movable between a first position and a second position. The system also includes a pawl lifter operatively associated with the pawl, the pawl lifter movable between a switch-off position when the pawl is in the first position and a switch-on position when the pawl is in the second position, and a pawl switch configured to generate a pawl switch signal, the pawl lifter engaging the pawl switch to an “on” condition when the pawl lifter is in the switch-on position, and the pawl lifter disengaging the pawl switch to an “off” condition when the pawl lifter is in the switch-off position.

### CROSS REFERENCE TO RELATED APPLICATIONS

This application claims foreign priority to French Patent Application No. 13/62345 filed on Dec. 10, 2013, under 35 U.S.C. §119, the contents of which are incorporated herein by reference thereto.

### BACKGROUND

Exemplary embodiments of the present invention relate generally to latches and, more particularly, to latches for vehicles.

Some known vehicles typically include displaceable panels such as doors, windows, hood, trunk lid, hatch and the like which are affixed for hinged or sliding engagement with a vehicle body. Cooperating systems of latches and strikers are typically provided to ensure that such panels remain secured in their fully closed position when the panel is closed.

A latch typically includes a fork bolt or claw that is pivoted between an unlatched position and a primary latched position when the door is closed to latch the door in the closed position. The fork bolt is typically held in the primary latched position by a detent lever or pawl that pivots between an engaged position and a disengaged position. The detent lever holds the fork bolt in the primary latched position when in the engaged position and releases the fork bolt when in the disengaged position so that the door can be opened.

The fork bolt is pivoted to the primary latched position by a striker attached to, for example, an associated doorjamb when the door is closed. Once in the primary latched position, the detent lever engages the fork bolt to ensure the assembly remains latched.

In some known vehicles, doors may be automatically power closed by a motor when the door is in a certain position, for example, a first safety position. Due to a high clearance during transition to the latch closing position, a switch associated with the detent lever may fail to indicate when the door is closed. This may lead to the motor operating in a stall position for an undesirable amount of time. Accordingly, it is desirable to provide an improved latch assembly.

### SUMMARY OF THE INVENTION

In one non-limiting embodiment, a latch assembly is provided. The latch assembly includes a claw movable between a latched position and an unlatched position, and a pawl movable between a first position and a second position, the pawl engaging and holding the claw in the latched position when the pawl is in the first position, the pawl disengaging the claw for movement to the unlatched position when the pawl is in the second position. The system also includes a pawl lifter operatively associated with the pawl, the pawl lifter movable between a switch-off position when the pawl is in the first position and a switch-on position when the pawl is in the second position, and a pawl switch configured to generate a pawl switch signal, the pawl lifter engaging the pawl switch to an “on” condition when the pawl lifter is in the switch-on position, and the pawl lifter disengaging the pawl switch to an “off” condition when the pawl lifter is in the switch-off position.

In another non-limiting embodiment, a vehicle is provided. The vehicle includes a controller, a door, and a door latch assembly. The door latch assembly includes a claw movable between a latched position and an unlatched position, and a pawl movable between a first position and a second position, the pawl engaging and holding the claw in the latched position when the pawl is in the first position, the pawl disengaging the claw for movement to the unlatched position when the pawl is in the second position. The assembly further includes a pawl lifter operatively associated with the pawl, the pawl lifter movable between a switch-off position when the pawl is in the first position and a switch-on position when the pawl is in the second position, and a pawl switch communicatively coupled to the controller, the pawl switch configured to generate a pawl switch signal, the pawl lifter engaging the pawl switch to an “on” condition when the pawl lifter is in the switch-on position, and the pawl lifter disengaging the pawl switch to an “off” condition when the pawl lifter is in the switch-off position.

In yet another non-limiting embodiment, a method of detecting the position of a door of a vehicle is provided, the vehicle having a latch assembly including a claw, a pawl, a switch cam operatively associated with the claw, a pawl lifter operatively associated with the pawl, a pawl switch, and a controller. The method includes providing the claw movable between a latched position and an unlatched position, providing the pawl movable between a first position and a second position, the pawl engaging and holding the claw in the latched position when the pawl is in the first position, the pawl disengaging the claw for movement to the unlatched position when the pawl is in the second position, and operatively associating the pawl lifter with the pawl such that the pawl lifter is movable between a switch-off position when the pawl is in the first position and a switch-on position when the pawl is in the second position. The method further includes providing a pawl switch communicatively coupled to the controller and configured to generate a pawl switch signal, and orienting the pawl switch such that the pawl lifter engages the pawl switch to an “on” condition when the pawl lifter is in the switch-on position, and the pawl lifter disengages the pawl switch to an “off” condition when the pawl lifter is in the switch-off position. The method further includes indicating to the controller, with the pawl switch signal, a door open position condition of the latch assembly when the pawl switch is in the “on” condition, and indicating to the controller, with the pawl switch signal, a door safety position or closed condition of the latch assembly when the pawl switch is in the “off” condition.

The above-described and other features and advantages of the present invention will be appreciated and understood by those skilled in the art from the following detailed description, drawings, and appended claims.

### BRIEF DESCRIPTION OF THE DRAWINGS

Embodiments of the present invention will now be described, by way of example only, with reference to the accompanying drawings in which:

FIG. 1 is a side view of a latch assembly in an open position according to an embodiment of the invention;

FIG. 2 is a side view of the latch assembly in a safety position according to an embodiment of the invention;

FIG. 3 is a side view of the latch assembly in a closed position according to an embodiment of the invention;

FIG. 4 is a schematic view of an embodiment of a latch connector that may be used with the latch assembly shown in FIGS. 1-3;

FIG. 5 is a schematic view of another embodiment of a latch connector that may be used with the latch assembly shown in FIGS. 1-3;

FIG. 6 is a graph showing the operational relationship among the latch assembly, a claw switch, a pawl switch, and the latch connector shown in FIG. 4;

FIG. 7 is a chart showing the operational relationship among the latch assembly, the claw switch, the pawl switch, and the latch connector shown in FIG. 4;

FIG. 8 is a graph showing the operational relationship among the latch assembly, the claw switch, the pawl switch, and the latch connector shown in FIG. 5; and

FIG. 9 is a chart showing the operational relationship among the latch assembly, the claw switch, the pawl switch, and the latch connector shown in FIG. 5.

### DETAILED DESCRIPTION

Described herein is an exemplary latch assembly that includes an integrated pawl switch for use in detecting a true position of a vehicle door, such as a power sliding door. The pawl switch is connected in parallel with a claw switch using existing electrical wiring such that the switches provide an electrical status of the latch in different door positions.

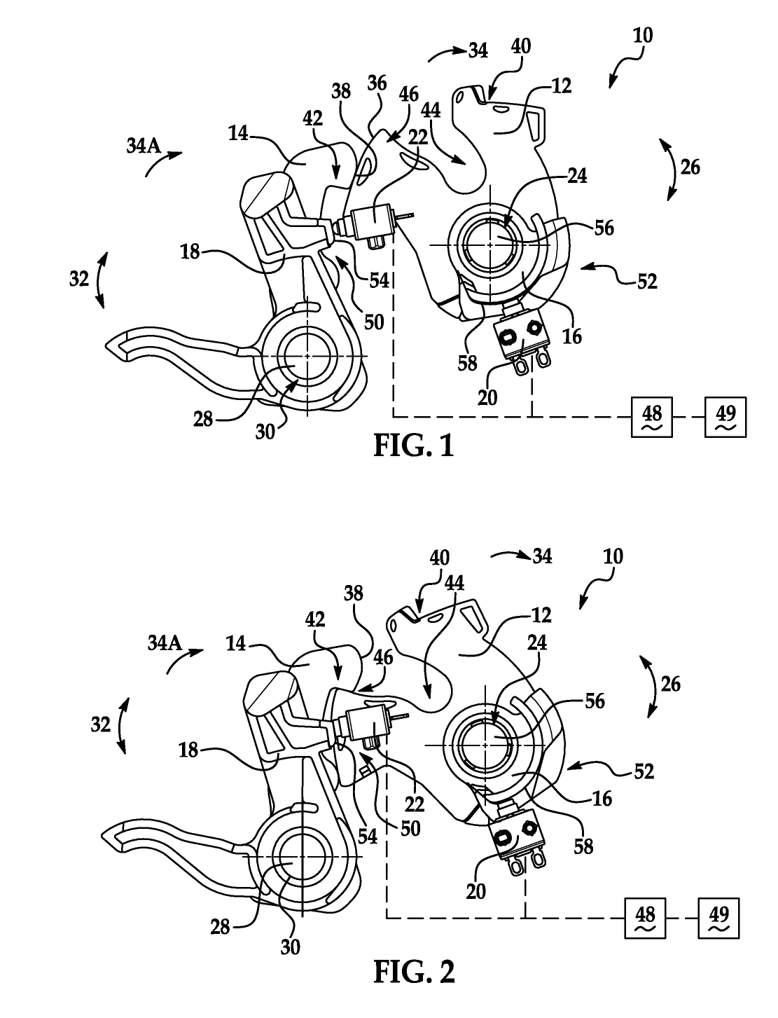

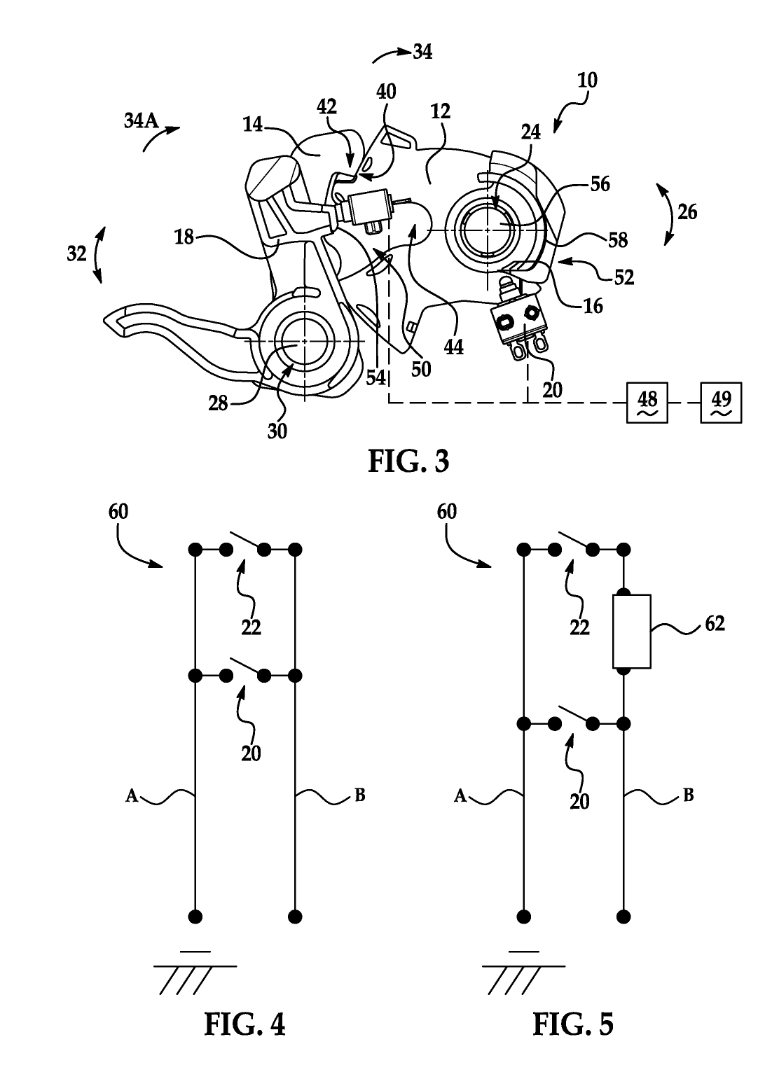

Referring now to the FIGS., an exemplary latch assembly 10 is illustrated in an open position (FIG. 1), an intermediate safety position (FIG. 2), and a closed position (FIG. 3). Latch assembly 10 may be integrated into a component of a vehicle, such as the vehicle door, trunk, frame surrounding the door opening or trunk opening, or any other operable component for example. Latch assembly 10 generally includes a claw 12, a cooperating pawl 14, a switch cam 16, a pawl lifter 18, a claw switch 20, and a pawl switch 22.

Claw 12 is pivotally or rotationally mounted about a pin 56 that is received within an opening 24. Claw 12 is capable of rotational movement between an open or unlatched position shown in FIG. 1 and a closed or latched position shown in FIG. 3, wherein claw 12 rotates in the direction of arrows 26.

Latch assembly 10 is attached to a vehicle structure such that claw 12 is moved between the open position (FIG. 1) and the closed position (FIG. 3) when a door, window, lift gate, etc. is opened and closed and claw 12 engages a striker (not shown) that is attached to the door, window, lift gate, etc. In the exemplary embodiment, latch assembly 10 includes safety position (FIG. 2) that is an intermediate position between the open position and the closed position. In other embodiments, latch assembly 10 is secured to the door, window, lift gate, etc. and the striker is secured to the vehicle body at an opening into which the door, window, lift gate, etc. is received. The cooperation of a claw and striker is well known and need not be described in detail.

Pawl 14 is pivotally mounted by a stud 28 received within a stud aperture 30 formed within pawl 14. Pawl 14 cooperates with claw 12 in a well-known manner to retain claw 12 in the safety position (FIG. 2) and the closed position (FIG. 3), or release claw 12 for return to the open position (FIG. 1). That is, pawl 14 pivots between a release or disengaged first position shown in FIG. 1 in the direction of arrows 32, a closed or engaged second position shown in FIG. 2, and a closed or engaged third position shown in FIG. 3. In the exemplary embodiment, claw 12 is spring biased clockwise to the open position shown in FIG. 1 or in the direction of arrow 34 by a biasing member (not shown; e.g., coil or torsion spring or other equivalent member) that has one end attached to claw 12 and the other end attached to a housing or other equivalent location. Similarly, a biasing member (not shown) biases pawl 14 in the direction of arrow 34A against a face of claw 12.

In the exemplary embodiment, claw 12 has a surface 36 that slides along a complimentary surface 38 of pawl 14 when claw 12 rotates from the open position (FIG. 1) to the closed position (FIG. 3). Once in the closed position (FIG. 3), a claw shoulder portion 40 engages a pawl shoulder portion 42 thus engaging claw 12 and securing it into the closed position when the striker is secured in a receiving opening 44 of claw 12. Once the latch assembly 10 is in the closed position, pawl 14 is spring biased in the direction of arrow 34A and shoulder 40 engages shoulder 42 such that claw 12 cannot rotate into the open position unless pawl 14 is moved back to the release position (e.g., moving shoulder 42 away from shoulder 40) allowing claw 12 to rotate in the direction of arrow 34 into the open position.

Claw 12 also includes a second shoulder portion 46 that is engaged by pawl shoulder portion 42 when claw 12 has been engaged by the striker as the door is closed to the safety position (FIG. 2), at which point the door is still slightly ajar, with little or no compression of its weather seals (not shown), for example. Once in the safety position (FIG. 2), claw second shoulder portion 46 engages pawl shoulder portion 42 thus engaging claw 12 and securing it into the first safety position. Once latch assembly 10 is in the closed position, pawl 14 is spring biased in the direction of arrow 34A and shoulder 46 engages shoulder 42 such that claw 12 cannot rotate into the open position unless pawl 14 is moved back to the release position (e.g., moving shoulder 42 away from shoulder 40) allowing claw 12 to rotate in the direction of arrow 34 into the open position. Further, in the exemplary embodiment, once latch assembly 10 is in the first safety position, a controller 48 in communication with a power closing mechanism 49 (shown schematically) actuates power closing mechanism 49 to transition assembly 10 to the closed position (FIG. 3).

In the exemplary embodiment, latch assembly 10 includes a pawl sensor assembly 50 and a claw sensor assembly 52, which are in communication with controller 48.

Pawl sensor assembly 50 includes pawl switch 22 and pawl lifter 18, which facilitates transitioning pawl switch 22 between an “on” condition and an “off” condition for communication with controller 48. Pawl lifter 18 is pivotally or rotationally mounted by stud 28 received within stud aperture 30, and pawl lifter 18 may rotate with pawl 14 during rotation of pawl lifter 18. In the exemplary embodiment, pawl lifter 18 includes an engagement surface 54 configured to selectively engage pawl switch 22. In the open position (FIG. 1), engagement surface 54 is not in contact with pawl switch 22 such that pawl lifter 18 is in the switch-on position. Engagement surface 54 contacts pawl switch 22 when claw 12 is in the safety position (FIG. 2) and in the closed position (FIG. 3) such that pawl lifter 18 is in a switch-off position.

Claw sensor assembly 52 includes claw switch 20 and switch cam 16, which facilitates transitioning claw switch 20 between an “on” condition and an “off” condition for communication with controller 48. Switch cam 16 is pivotally or rotationally mounted by a pin 56 received within claw opening 24, and switch cam 16 may rotate with claw 12 during rotation of switch cam 16. In the exemplary embodiment, switch cam 16 includes a contact surface 58 configured to selectively engage claw switch 20. In the open position (FIG. 1) and in the safety position (FIG. 2), contact surface 58 is in contact with claw switch 20 such that switch cam 16 is in a switch-on position. Contact surface 58 does not contact claw switch 20 when claw 12 is in the closed position (FIG. 3) such that switch cam 16 is in a switch-off position.

In the exemplary embodiment, claw switch 20 and pawl switch 22 are each microswitches that provide a signal to controller 48, as described herein in more detail. However, switches 20 and 22 may be any suitable switch or sensor that enables assembly 10 to function as described herein. Claw switch 20 is positioned to engage switch cam 16 such that rotation of claw 12 from the closed position to the safety position and/or open position causes claw switch 20 to transition from an “off” position to an “on” position. Although described as “off” and “on” positions, claw switch 20 have may any suitable position or condition that enables system 10 to function as described herein. In the “off” position, claw switch 20 sends a signal (or indicates a lack of a signal) to controller 48 to indicate that latch assembly 10 is in the closed position (FIG. 3). In the “on” position, claw switch 20 sends a signal (or indicates a lack of a signal) to controller 48 to indicate that latch assembly 10 is in the safety position (FIG. 2) or the open position (FIG. 1).

In the exemplary embodiment, pawl switch 22 is positioned to engage pawl lifter 18 such that rotation of pawl 14 from the first position (FIG. 1) to the second position (FIG. 2) or the third position (FIG. 3) causes pawl switch 22 to transition from an “on” position to an “off” position. Although described as “off” and “on” positions, pawl switch 22 have may any suitable position or condition that enables system 10 to function as described herein. In the “off” position, pawl switch 22 sends a signal (or indicates a lack of a signal) to controller 48 to indicate that latch assembly 10 is in the first safety position (FIG. 2) or the closed position (FIG. 3). In the “on” position, pawl switch 22 sends a signal (or indicates a lack of a signal) to controller 48 to indicate that latch assembly 10 is in the open position (FIG. 1).

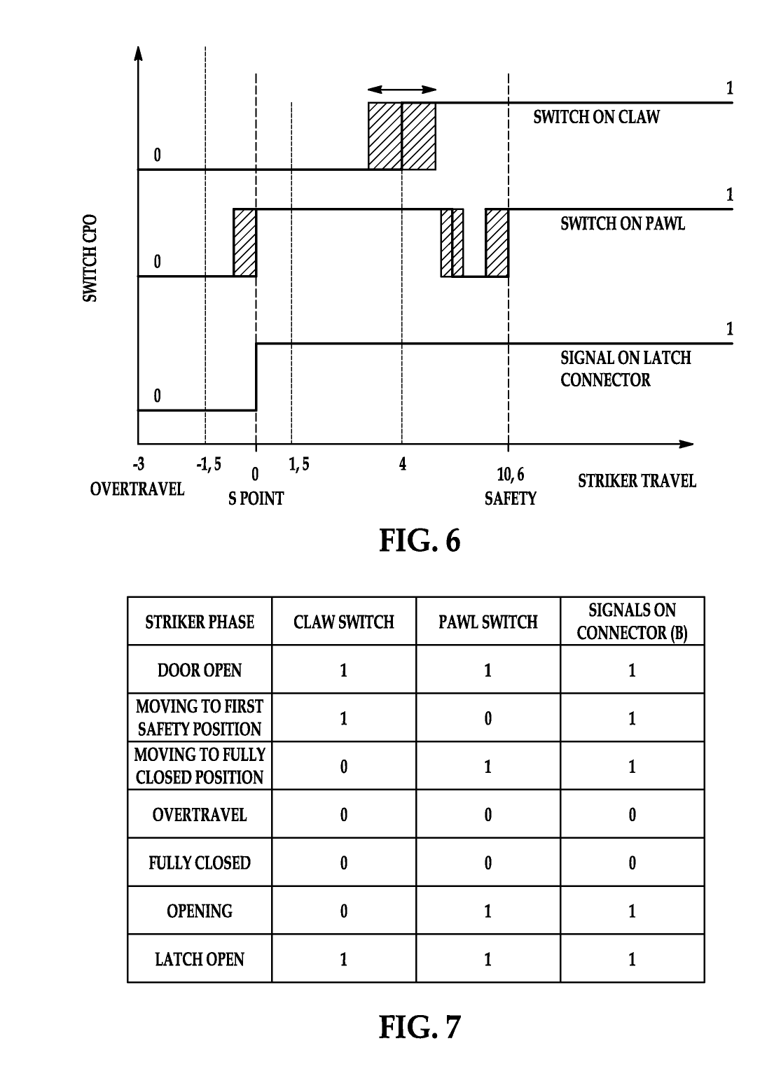

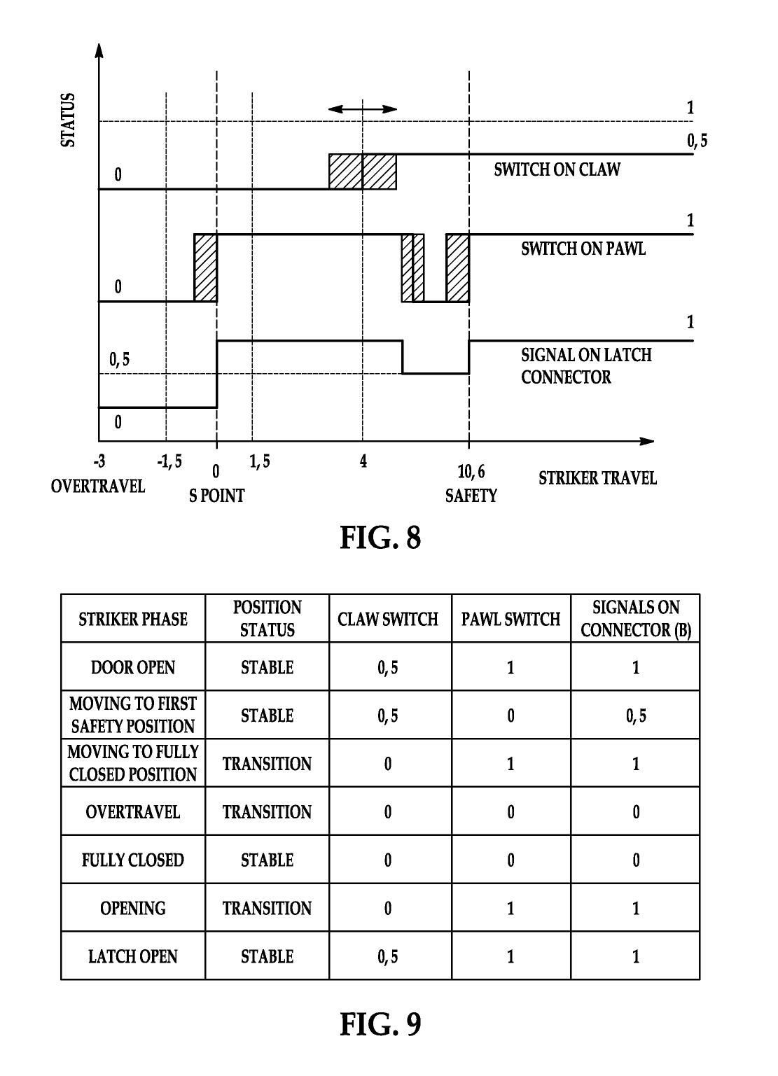

As shown in FIG. 4, latch assembly 10 includes an electrical circuit or latch connector 60 where pawl switch 22 is connected in parallel with claw switch 20 such that only two wires A, B are required to communicatively couple switches 20 and 22 to controller 48. FIG. 5 illustrates an alternative embodiment of latch connector 60 that includes a resistor 62 connected in serial with claw switch 20, which facilitates controller 48 detecting when latch assembly 10 is in the safety position (FIG. 2). As such, a different voltage is on the wire due to resistor 62, which provides at least three different types of signals to controller 48. For example, with reference to FIGS. 6 and 8, a 0 (zero) signal may indicate no resistance, a 0.5 signal may indicate an intermediate resistance, and a 1 signal may indicate a high resistance. Controller 48 may then translate these signals to determine the position or condition of latch assembly 10.

With reference to FIGS. 6-9, an exemplary operation of latch assembly 10 is described herein. FIGS. 6-9 illustrate correlations among the position of a vehicle door corresponding to the position of latch assembly 10, the output signal from claw switch 20, the output signal from pawl switch 22, and a signal result on latch connector 60 wire B. FIGS. 6 and 7 illustrate correlations when latch connector 60 does not include resistor 62, and FIGS. 8 and 9 illustrate correlations when latch connector 60 includes resistor 62.

In the exemplary operation, claw 12 begins in an unlatched position (FIG. 1) corresponding to a component such as a vehicle door being in an open position. Switch cam 16 is oriented in the switch-on position such that switch cam contact surface 58 contacts claw switch 20 into the “on” state where claw switch 20 sends a signal to controller 48 indicating the vehicle door is in the open/safety position. Pawl 14 is in the first position and pawl lifter 18 is oriented in the switch-on position such that pawl lifter engagement surface 54 does not contact pawl switch 22. As such, pawl switch 22 is in the “on” state where pawl switch 22 sends a signal to controller 48 that indicates the vehicle door is in the open position. Accordingly, switches 20, 22 indicate to controller 48 that the vehicle door is open.

As the vehicle door moves from the open position (FIG. 1) to the safety position (FIG. 2), claw 12 rotates counter-clockwise and pawl 14 rotates from the first position (FIG. 1) where it is disengaged from claw 12 to the second position (FIG. 2) where pawl shoulder 42 engages claw shoulder 40 to prevent the vehicle door from accidentally moving to the open position. As such, contact surface 58 remains in contact with claw switch 20, and pawl 14 has rotated clockwise causing engagement surface 54 to contact pawl switch 22, thereby transitioning switch 22 to the “off” condition. As such, claw switch 20 sends a signal to controller 48 indicating that the vehicle door is in the open or safety position, and pawl switch 22 sends a signal to controller 48 that indicates the vehicle door is in the safety or closed position. Controller 48 may subsequently actuate the motor of power closing mechanism 49 to commence a power close operation where claw 12 is rotated counter-clockwise into the latched position (FIG. 3) to safely secure the door in a closed position.

As the vehicle door moves from the safety position (FIG. 2) to the closed position (FIG. 3), claw 12 rotates to the latched position and pawl 14 rotates to the third position (FIG. 3). Accordingly, in the door closed position, engagement surface 54 remains in contact with pawl switch 22, and switch cam 16 has been rotated out of engagement with claw switch 20, thereby transitioning switch 20 to the “off” condition. As such, claw switch 20 sends a signal to controller 48 that indicates the vehicle door is in the closed position. Controller 48 may then cease the power close operation and power-off the power close mechanism motor.

As the vehicle door returns to the open position (FIG. 1), pawl 14 disengages claw 12, and claw 12 rotates clockwise from the latched position (FIG. 3) to the unlatched position (FIG. 1). As such, contact surface 58 engages claw switch 20 indicating to controller 48 a door open or safety position, and pawl lifter 18 rotates out of engagement with pawl switch 22 indicating to controller 48 a door open position. The operation of latch assembly 10 may then be repeated as the door again moves from the open position (FIG. 1), to the safety position (FIG. 2), and to the closed position (FIG. 3).

Described herein is a latch assembly for detecting a position of a vehicle door. The latch assembly includes a claw switch and a pawl switch connected in parallel. Economically, the claw switch and pawl switch may be coupled in parallel using only two wires. The switches are communicatively coupled to a controller (e.g., vehicle electronics) and are selectively engaged by portions of the latch assembly to indicate various positions of the vehicle door depending on whether the switches are in an “on/off” condition. Further, a resistor may be coupled in serial with the claw switch. Accordingly, the dual switches facilitate improved indication of door position, and thus, improved door operation, improved door closure safety, and increased vehicle occupant safety.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A latch assembly comprising:
a claw movable between a latched position and an unlatched position;
a pawl movable between a first position and a second position, said pawl engaging and holding said claw in said latched position when said pawl is in said first position, said pawl disengaging said claw for movement to said unlatched position when said pawl is in said second position;
a pawl lifter operatively associated with said pawl, said pawl lifter movable between a switch-off position when said pawl is in said first position and a switch-on position when said pawl is in said second position; and
a pawl switch configured to generate a pawl switch signal, said pawl lifter engaging said pawl switch to an “on” condition when said pawl lifter is in said switch-on position, and said pawl lifter disengaging said pawl switch to an “off” condition when said pawl lifter is in said switch-off position.

2. The latch assembly of claim 1, wherein said pawl switch signal indicates a door open condition of said latch assembly when said pawl switch is in said “on” condition, and said pawl switch signal indicates a door safety position or closed condition of said latch assembly when said pawl switch is in said “off” condition.

3. The latch assembly of claim 1, further comprising:
a switch cam operatively associated with said claw, said switch cam movable between a switch-off position when said claw is in said latched position and a switch-on position when said claw is in said unlatched position; and
a claw switch configured to generate a claw switch signal, said switch cam engaging said claw switch to an “on” condition when said switch cam is in said switch-on position, and said switch cam disengaging said claw switch to an “off” condition when said switch cam is in said switch-off position.

4. The latch assembly of claim 3, wherein said claw switch signal indicates a door safety position or open condition of said latch assembly when said claw switch is in said “on” condition, and said claw switch signal indicates a door closed condition of said latch assembly when said claw switch is in said “off” condition.

5. The latch assembly of claim 3, wherein said pawl switch and said claw switch are coupled in parallel in an electrical circuit.

6. The latch assembly of claim 5, further comprising a resistor coupled in series with said claw switch in said electrical circuit.

7. The latch assembly of claim 5, further comprising a controller, said pawl switch and said claw switch communicatively coupled to said controller via a common wire.

8. The latch assembly of claim 7, wherein said pawl switch and said claw switch are coupled to each other by only two wires.

9. A vehicle comprising:
a controller;
a door; and
a door latch assembly comprising:
a claw movable between a latched position and an unlatched position;
a pawl movable between a first position and a second position, said pawl engaging and holding said claw in said latched position when said pawl is in said first position, said pawl disengaging said claw for movement to said unlatched position when said pawl is in said second position;
a pawl lifter operatively associated with said pawl, said pawl lifter movable between a switch-off position when said pawl is in said first position and a switch-on position when said pawl is in said second position; and
a pawl switch communicatively coupled to said controller, said pawl switch configured to generate a pawl switch signal, said pawl lifter engaging said pawl switch to an “on” condition when said pawl lifter is in said switch-on position, and said pawl lifter disengaging said pawl switch to an “off” condition when said pawl lifter is in said switch-off position.

10. The vehicle of claim 9, wherein said door is a sliding door.

11. The vehicle of claim 9, wherein said paw switch signal indicates to said controller a door open condition of said latch assembly when said pawl switch is in said “on” condition, and said pawl switch signal indicates to said controller a door safety position or closed condition of said latch assembly when said pawl switch is in said “off” condition.

12. The vehicle of claim 9, further comprising:
a switch cam operatively associated with said claw, said switch cam movable between a switch-off position when said claw is in said latched position and a switch-on position when said claw is in said unlatched position; and
a claw switch communicatively coupled to said controller, said claw switch configured to generate a claw switch signal, said switch cam engaging said claw switch to an “on” condition when said switch cam is in said switch-on position, and said switch cam disengaging said claw switch to an “off” condition when said switch cam is in said switch-off position.

13. The vehicle of claim 12, wherein said claw switch signal indicates to said controller a door safety position or open condition of said latch assembly when said claw switch is in said “on” condition, and said claw switch signal indicates to said controller a door closed condition of said latch assembly when said claw switch is in said “off” condition.

14. The vehicle of claim 12, wherein said pawl switch and said claw switch are coupled in parallel in an electrical circuit.

15. The vehicle of claim 14, further comprising a resistor coupled in series with said claw switch in said electrical circuit.

16. The vehicle of claim 14, wherein said electrical circuit comprises only two wires.

17. A method of detecting the position of a door of a vehicle having a latch assembly comprising a claw, a pawl, a switch cam operatively associated with the claw, a pawl lifter operatively associated with the pawl, a pawl switch, and a controller, said method comprising:
providing the claw movable between a latched position and an unlatched position;
providing the pawl movable between a first position and a second position, the pawl engaging and holding the claw in the latched position when the pawl is in the first position, the pawl disengaging the claw for movement to the unlatched position when the pawl is in the second position;
operatively associating the pawl lifter with the pawl such that the pawl lifter is movable between a switch-off position when the pawl is in the first position and a switch-on position when the pawl is in the second position;
providing a pawl switch communicatively coupled to the controller and configured to generate a pawl switch signal;
orienting the pawl switch such that the pawl lifter engages the pawl switch to an “on” condition when the pawl lifter is in the switch-on position, and the pawl lifter disengages the pawl switch to an “off” condition when the pawl lifter is in the switch-off position;
indicating to the controller, with the pawl switch signal, a door open position condition of the latch assembly when the pawl switch is in the “on” condition; and
indicating to the controller, with the pawl switch signal, a door safety position or closed condition of the latch assembly when the pawl switch is in the “off” condition.

18. The method of claim 17, further comprising:
providing the switch cam operatively associated with the claw, the switch cam movable between a switch-off position when the claw is in the latched position and a switch-on position when the claw is in the unlatched position;
providing a claw switch communicatively coupled to the controller and configured to generate a claw switch signal;
orienting the claw switch such that the switch cam engages the claw switch to an “on” condition when the switch cam is in the switch-on position, and the switch cam disengages the claw switch to an “off” condition when the switch cam is in the switch-off position;
indicating to the controller, with the claw switch signal, a door safety position or open condition of the latch assembly when the claw switch is in the “on” condition; and
indicating to the controller, with the claw switch signal, a door closed condition of the latch assembly when the claw switch is in the “off” condition.

19. The method of claim 18, further comprising coupling the claw switch and the pawl switch in parallel in an electrical circuit.
